(19) United States
(12) Patent Application Publication
(10) Pub. No.: US 2024/0230075 A1
(43) Pub. Date: Jul. 11, 2024

(54) HANDS-FREE LIGHTING SYSTEMS

(71) Applicant: Ronald C. NGUYEN, Fountain Valley, CA (US)

(72) Inventor: Ronald C. NGUYEN, Fountain Valley, CA (US)

(21) Appl. No.: 18/586,612

(22) Filed: Feb. 26, 2024

Related U.S. Application Data
(63) Continuation of application No. 18/114,278, filed on Feb. 27, 2023.
Application No. 18/114,278 is a continuation of application No. 17/703,936, filed on Mar. 24, 2022, now abandoned.
Application No. 17/703,936 is a continuation of application No. 17/180,884, filed on Feb. 22, 2021, now abandoned.
Application No. 17/180,884 is a continuation of application No. 16/780,838, filed on Feb. 3, 2020, now abandoned.
Application No. 16/780,838 is a continuation of application No. 15/098,340, filed on Apr. 14, 2016, now abandoned.
Application No. 15/098,340 is a continuation-in-part of application No. 13/531,465, filed on Jun. 22, 2012, now abandoned.
(60) Provisional application No. 61/499,699, filed on Jun. 22, 2011.

(51) Int. Cl. F21V 23/04; F21L 4/06; F21L 4/08; F21V 23/02; F21W 131/20; G02B 25/00; G02C 7/08; H05B 47/115; H05B 47/13

(52) U.S. Cl. CPC F21V 23/0471; F21L 4/06; F21L 4/08; F21V 23/023; F21V 23/0414; G02B 25/00; G02C 7/08; H05B 47/115; H05B 47/13; F21W 2131/20

(57) ABSTRACT

Hands-free lighting systems are described. In one embodiment, a hands-free lighting system may comprise a light and a battery housing coupled to the light. The battery housing may be configured to be worn by a user. The hands-free lighting system may also comprise a power switch coupled to the battery housing. The power switch may be configured to be operated by a part of the arm of the user other than the hands. The power switch may include a touch-sensitive device having a capacitive surface.

### CROSS-REFERENCE TO RELATED APPLICATIONS

This application is a continuation of U.S. patent application Ser. No. 18/114,278, filed Feb. 27, 2023, which is a continuation of U.S. patent application Ser. No. 17/703,936, filed Mar. 24, 2022, which is a continuation of U.S. patent application Ser. No. 17/180,884, filed Feb. 22, 2021, which is a continuation of U.S. patent application Ser. No. 16/780,838, filed Feb. 3, 2020, which is a continuation of U.S. patent application Ser. No. 15/098,340, filed Apr. 14, 2016, which is a continuation-in-part of U.S. patent application Ser. No. 13/531,465, filed Jun. 22, 2012, which claims the benefit of U.S. provisional patent application no. 61/499,699, filed Jun. 22, 2011. The applications listed above are hereby incorporated by reference in their entireties.

### BACKGROUND

Loupe lights are lights attached to dental loupes or other eyewear to illuminate an area of interest. Loupe lights may be coupled by a wire to a battery pack or other power source.

Loupe lights may be turned on and off by a user. Loupe lights may also need to have a brightness adjusted. Power and brightness controls may allow a user to do these things.

However, a user may not be able to operate the power and brightness controls by touching the controls. The user's hands may be holding instruments. The user's hands may be soiled, and the user may wish to avoid soiling the battery pack and/or the user's clothing. The user's eyes may be focused on an area of interest, and the user may find it disadvantageous to look away from the area of interest to operate controls on the battery pack. Often, the user may have another person such as an assistant operate the controls.

What is needed is a light which may be turned on and off by a user without using the user's hands or without touching the controls. What is also needed is a light which may be adjusted in brightness by a user without using the user's hands or without touching the controls.

### SUMMARY

Hands-free lighting systems are described. In one embodiment, a hands-free lighting system may comprise a light and a battery housing coupled to the light. The battery housing may be configured to be worn by a user. The hands-free lighting system may also comprise a power switch coupled to the battery housing. The power switch may be configured to be operated by a part of the arm of the user other than the hands. The power switch may include a touch-sensitive device having a capacitive surface.

Methods of operating a hands-free lighting system are described. In one embodiment, a method may include turning a light on and off by using a part of the arm other than the hands to touch a touch-sensitive device having a capacitive surface. The touch-sensitive device may be coupled to a battery housing. The battery housing may be coupled to the light.

### BRIEF DESCRIPTION OF THE DRAWINGS

FIG. 1A shows one embodiment of a hands-free lighting system 100.

FIGS. 1B-1C show front and back views of one embodiment of battery housing 120.

FIGS. 1D-1F show alternative embodiments of power switch 140.

FIG. 1G shows brightness control 150 combined with power switch 140 into a single button 144.

FIG. 2A shows another embodiment of a hands-free lighting system 200.

FIG. 2B shows a front view of one embodiment of battery housing 220. FIG. 2C shows a front view of another embodiment of battery housing 220.

FIG. 3A shows yet another embodiment of a hands-free lighting system 300.

FIG. 3B shows power switch 240 as both pod buttons 234. FIG. 3C shows power switch 240 as a first pod button 234, and brightness control 250 as a second pod button 234.

FIG. 4A shows still another embodiment of a hands-free lighting system 400.

FIG. 4B shows power switch 240 as button 244 used as an on button and pod button 234 used as an off button.

FIG. 4C shows power switch 240 as button 244 and brightness control 250 as button 234.

FIGS. 5A-5C show one embodiment of a touch-free lighting system 500.

FIG. 5D shows one embodiment of a light 510 having a touch-free sensor 560.

FIG. 5E shows one embodiment of a battery housing 520 having a touch-free sensor 560.

### DESCRIPTION

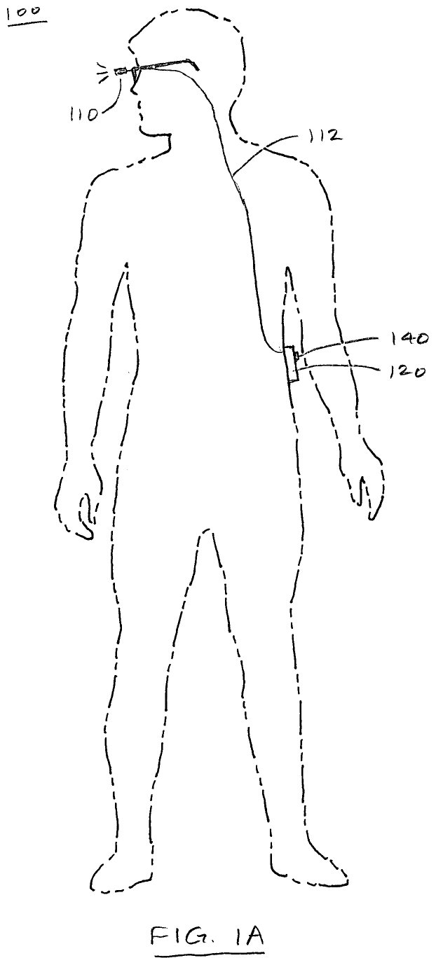

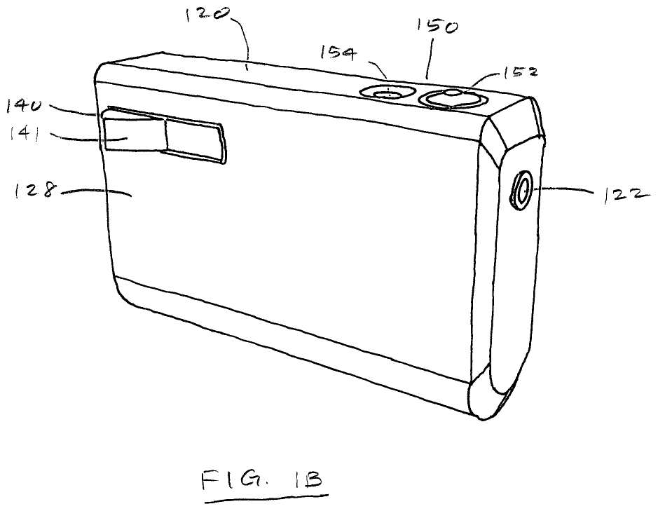

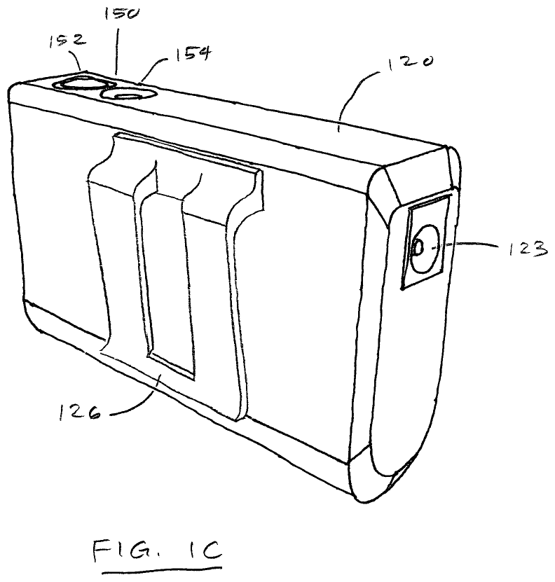

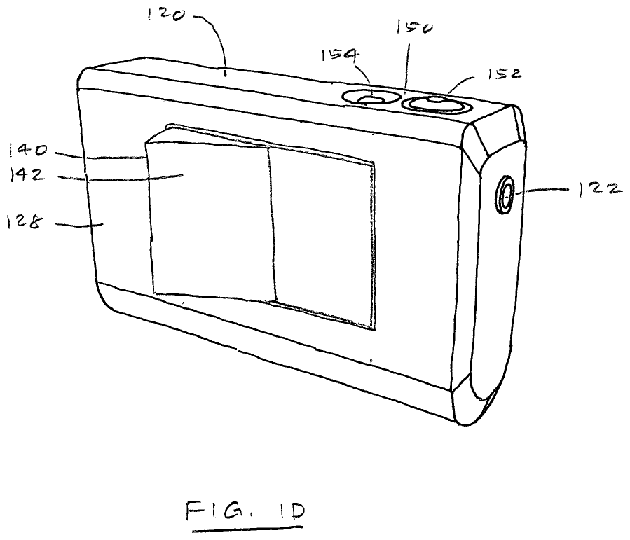

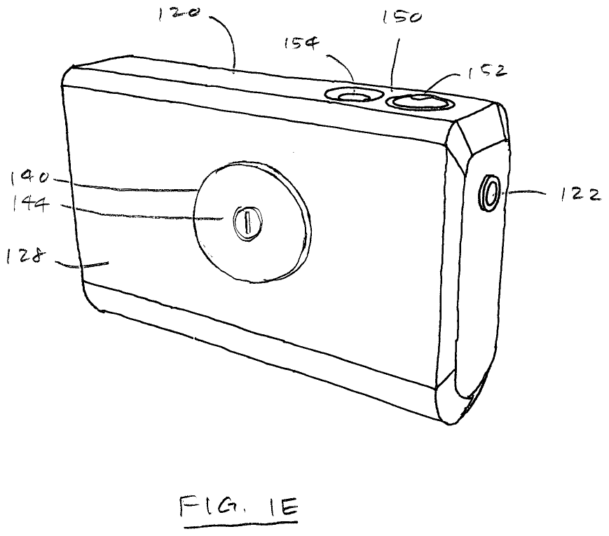

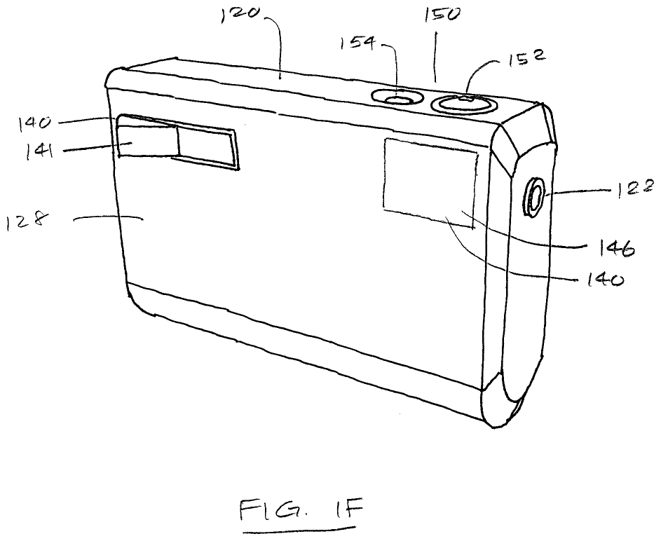

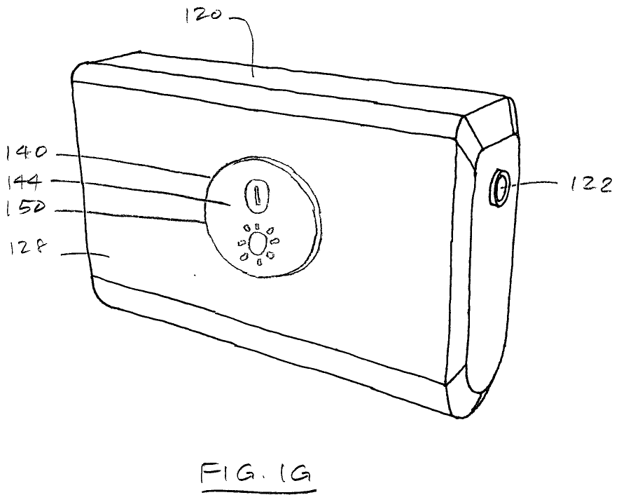

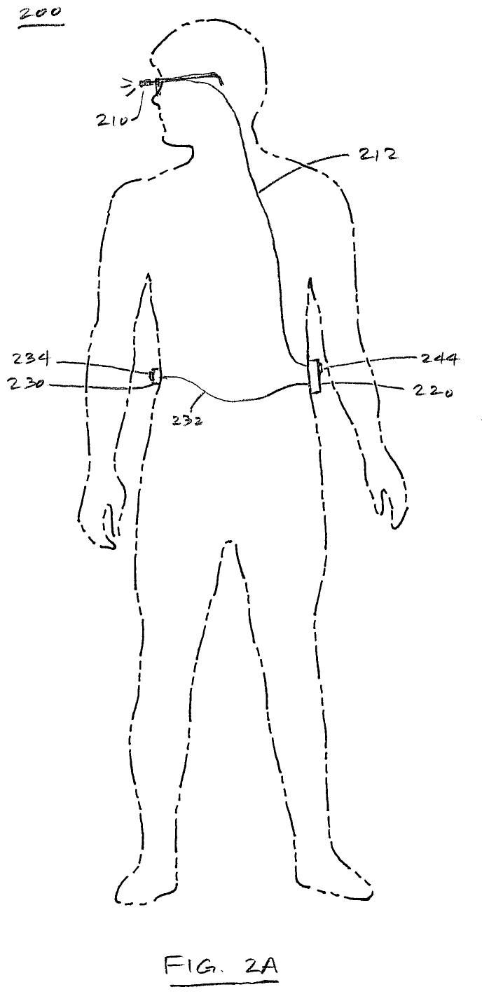

FIG. 1A shows one embodiment of a hands-free lighting system 100. Hands-free lighting system 100 includes a light 110, a battery housing 120, a power switch 140, and a brightness control 150.

Light 110 is shown as a loupe light, but may be any light for which hands-free operation is desired. Light 110 may include a wire 112 for connecting to a battery or power source.

FIGS. 1B-1C show front and back views of one embodiment of battery housing 120. Battery housing 120 is configured to contain a battery. Battery housing 120 may be sealed. Alternatively, battery housing 120 may be able to be opened to install or replace a battery. A light connector 122 may be located on battery housing 120 for connecting wire 112 of light 110. Alternatively, wire 112 of light 110 may be non-removably coupled to battery housing 120. Battery housing 120 may include a recharging port 123 for connecting to a power source to charge rechargeable batteries. Battery housing 120 may include an attachment 126 so that battery housing 120 may be worn by a user. Attachment 126 may be a belt clip, a belt loop, a hook-and-loop fastener, a strap, or any other suitable device which allows battery housing 120 to be worn by a user.

Battery housing 120 may have a slim or flat profile when worn against the user. Battery housing 120 may be worn on the side of the torso of the user, such as at the waist or under the armpit. Alternatively, battery housing 120 may be worn on the thigh of the user or any other suitable location. Battery housing 120 has an outer surface 128 which faces away from the user when worn by the user.

Power switch 140 allows a user to turn light 110 on and off. FIG. 1B shows power switch 140 as a rocker switch 141 located on outer surface 128 of battery housing 120. Power switch 140 is configured to be operated by a part of the arm of the user other than the hands. Power switch 140 may be operated by the inside of the elbow of the user. Alternatively, power switch 140 may be operated by the wrist, forearm, upper arm, or any other part of the arm of the user other than the hands.

FIGS. 1D-1F show alternative embodiments of power switch 140. FIG. 1D shows power switch 140 as a larger rocker switch 142. Larger rocker switch 142 may facilitate operation using a part of the arm other than the hands. FIG. 1E shows power switch 140 as a power button 144. Power button 144 may be pushed once to turn on light 110. Alternatively, power button 144 may be pushed and held down for a period of time to turn on light 110, or pushed two or more times to turn on light 110. Power button 144 may be used in the same or different way to turn off light 110. FIG. 1F shows power switch 140 as a touch-sensitive device 146. Touch-sensitive device 146 may include a capacitive surface responsive to touch and/or near-touch. Touch-sensitive device 146 may be responsive to bare and/or clothed skin. Touch-sensitive device 146 may be configured to be touched or near-touched for a period of time before turning on or off light 110 to prevent inadvertent operation. For example, touch-sensitive device 146 may need to be touched or near-touched for 0.5 sec to 1 sec before turning on or off light 110. Touch-sensitive device 146 may be substantially flush with outer surface 128. Touch-sensitive device 146 may be made any suitable size or shape. Touch-sensitive device 146 may be used alone or in conjunction with another power switch 140. Touch-sensitive device 146 may be used to control brightness. Touch-sensitive device 146 or additional touch-sensitive devices may be used instead of some or all of the buttons or switches for any of the devices described herein.

Brightness control 150 allows a user to adjust the brightness of light 110. FIGS. 1B-1E show brightness control 150 as a plus button 152 and a minus button 154 for increasing and decreasing, respectively, a brightness of light 110. Plus button 152 and minus button 154 may be textured differently, be convex or concave, or otherwise have different profiles to allow a user to distinguish between the two without looking. Alternatively, brightness control 150 may be a single button which increases the brightness of light 110 with each push, and returns to the lowest brightness when the button is pushed after the maximum brightness is reached. Brightness control 150 may be located on a surface of battery housing 120 other than outer surface 128 to avoid inadvertent operation of brightness control 150. FIG. 1G shows brightness control 150 combined with power switch 140 into a single button 144 which turns on or increases the brightness of light 110 with each push, and returns light 110 to off when the button is pushed after the maximum brightness is reached.

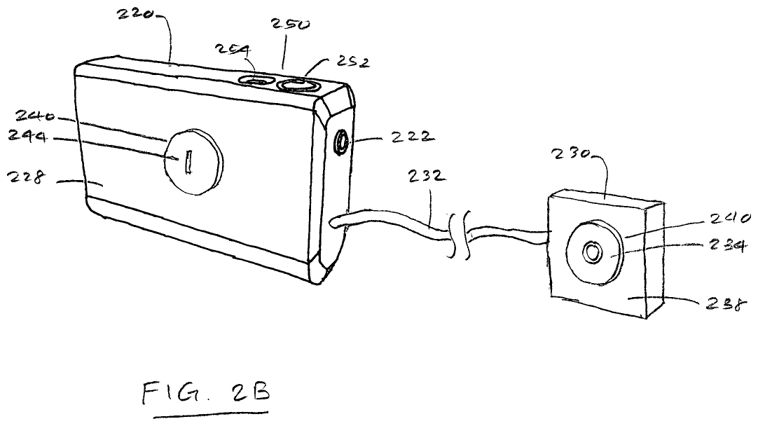

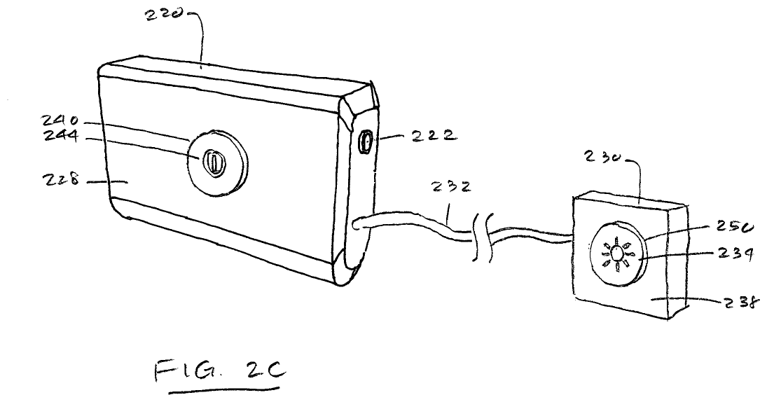

FIG. 2A shows another embodiment of a hands-free lighting system 200. Hands-free lighting system 200 includes a light 210, a battery housing 220, a pod 230, a power switch 240, and a brightness control 250.

Light 210 is shown as a loupe light, but may be any light for which hands-free operation is desired. Light 210 may include a wire 212 for connecting to a battery or power source.

FIG. 2B shows a front view of one embodiment of battery housing 220. Battery housing 220 is configured to contain a battery. Battery housing 220 may be sealed. Alternatively, battery housing 220 may be able to be opened to install or replace a battery. A light connector 222 may be located on battery housing 220 for connecting to wire 212 of light 210. Alternatively, wire 212 of light 210 may be non-removably coupled to battery housing 220. Battery housing 220 may include a recharging port 223 for connecting to a power source to charge rechargeable batteries. Battery housing 220 may include an attachment 226 so that battery housing 220 may be worn by a user. Attachment 226 may be a belt clip, a belt loop, a hook-and-loop fastener, a strap, or any other suitable device which allows battery housing 220 to be worn by a user.

Battery housing 220 may have a slim or flat profile when worn against the user. Battery housing 220 may be worn on the side of the torso of the user, such as at the waist or under the armpit. Alternatively, battery housing 220 may be worn on the thigh of the user or any other suitable location. Battery housing 220 has an outer surface 228 which faces away from the user when worn by the user.

Pod 230 is connected to battery housing 220 by a wire 232. Pod 230 may be removably or non-removably connected to battery housing 220. Pod 230 includes a pod button 234. Pod 230 may also include an attachment 236 similar to attachment 226 on battery housing 220, so that pod 230 may be worn by a user.

Power switch 240 allows a user to turn light 210 on and off. FIG. 2B shows power switch 240 as a button 244 used as an on button located on outer surface 228 of battery housing 220, and pod button 234 used as an off button. Alternatively, power switch 240 may be button 244 used as an off button, and pod button 234 used as an on button. Power switch 240 is configured to be operated by a part of both arms of the user other than the hands. Power switch 240 may be operated by the insides of the elbows of the user. Alternatively, power switch 240 may be operated by the wrists, forearms, upper arms, or any other parts of the arms of the user other than the hands.

Battery housing 220 and pod 230 may be worn on both sides of a body of a user so that button 244 and pod button 234 may be operated by a part of both arms of the user other than the hands. One arm may operate button 244 while the other may operate pod button 234. Button 244 or pod button 234 used as an on button may be pushed once to turn on light 210. Alternatively, button 244 or pod button 234 used as an on button may be pushed and held down for a period of time to turn on light 210, or pushed two or more times to turn on light 210. Button 244 or pod button 234 used as an off button may be used in the same or different way to turn off light 210.

Brightness control 250 allows a user to adjust the brightness of light 210. FIG. 2B shows brightness control 250 as a plus button 252 and a minus button 254 for increasing and decreasing, respectively, a brightness of light 210. Plus button 252 and minus button 254 may be textured differently, be convex or concave, or otherwise have different profiles to allow a user to distinguish between the two without looking. Brightness control 250 may be located on a surface of battery housing 220 other than outer surface 228 to avoid inadvertent operation of brightness control 250. FIG. 2C shows brightness control 250 as pod button 234, and power switch 240 as button 244. Brightness control 250 may increase the brightness of light 210 with each push of pod button 234, and returns to the lowest brightness when pod button 234 is pushed after the maximum brightness is reached. Alternatively, brightness control 250 may be button 244, and power switch 240 may be button 234.

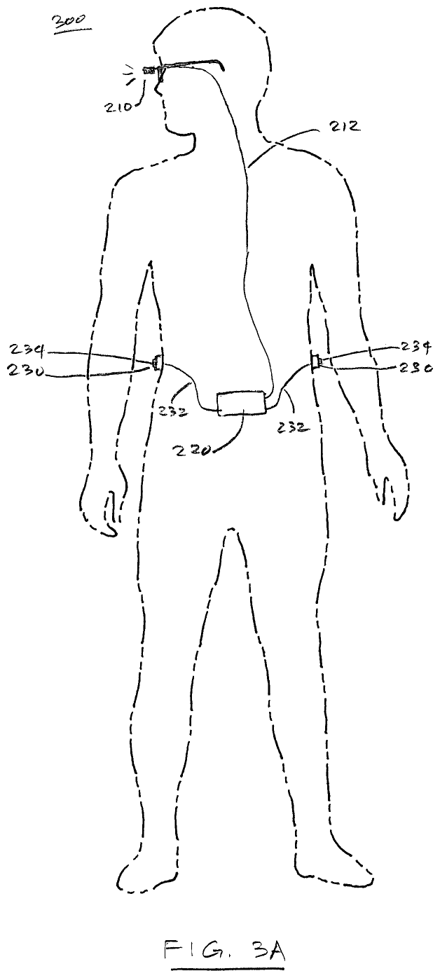

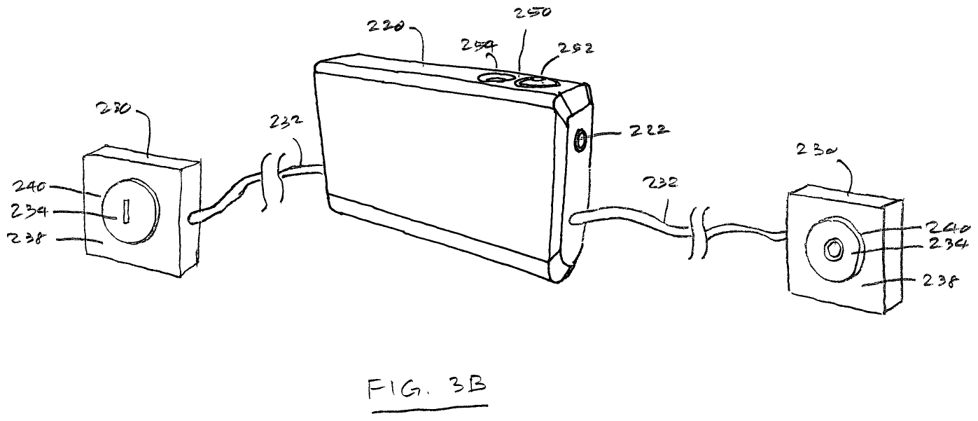

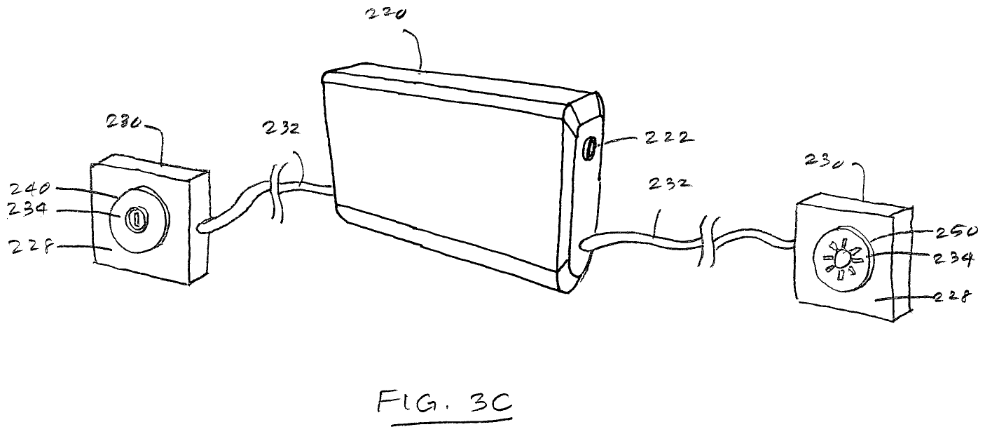

FIG. 3A shows yet another embodiment of a hands-free lighting system 300. Hands-free lighting system 300 is similar to hands-free lighting system 200, with two pods 230.

FIG. 3B shows power switch 240 as both pod buttons 234, with a first pod button 234 turning on light 210 on and a second pod button 234 turning off light 210. Brightness control 250 is located on battery housing 220. FIG. 3C shows power switch 240 as a first pod button 234, and brightness control 250 as a second pod button 234.

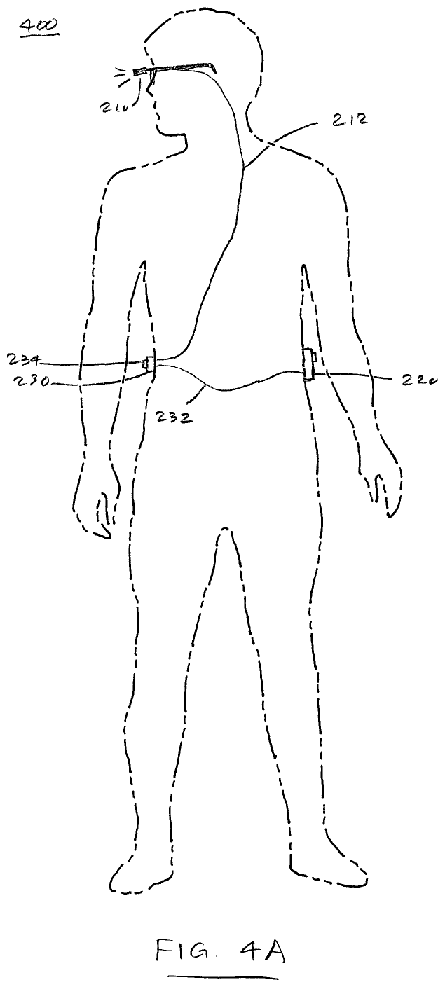

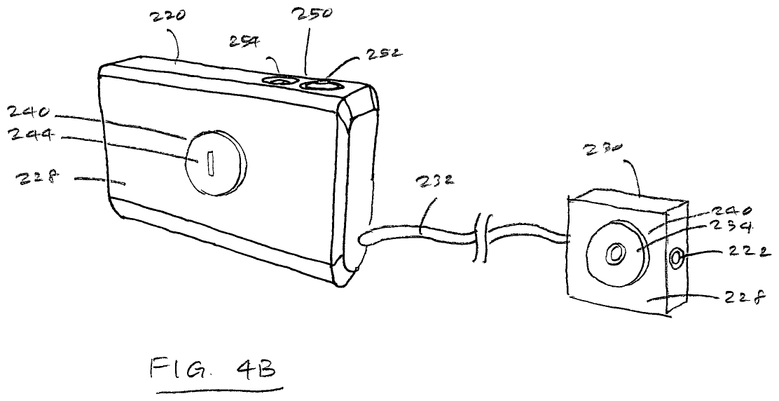

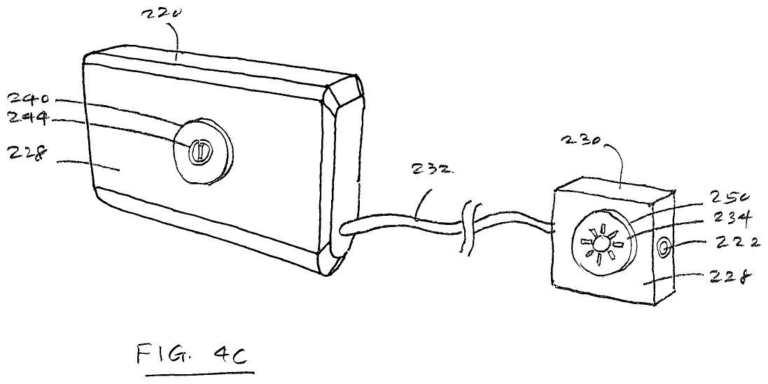

FIG. 4A shows still another embodiment of a hands-free lighting system 400. Hands-free lighting system is similar to hands-free lighting system 200, with a light connector 122 on pod 230 for connecting wire 212 of light 110. Alternatively, wire 212 of light 210 may be non-removably coupled to pod 230.

FIG. 4B shows power switch 240 as button 244 used as an on button and pod button 234 used as an off button. Alternatively, power switch 240 may be button 244 used as an off button, and pod button 234 used as an on button.

FIG. 4C shows power switch 240 as button 244 and brightness control 250 as button 234. Alternatively, power switch 240 may be button 234, and brightness control 250 may be button 244.

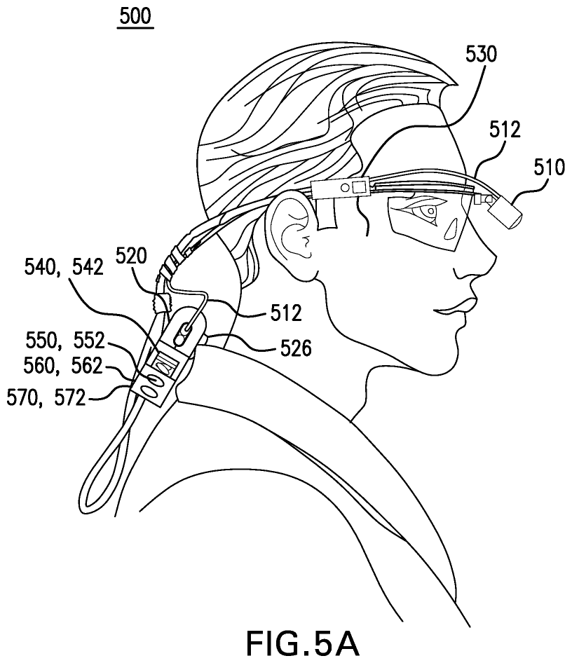

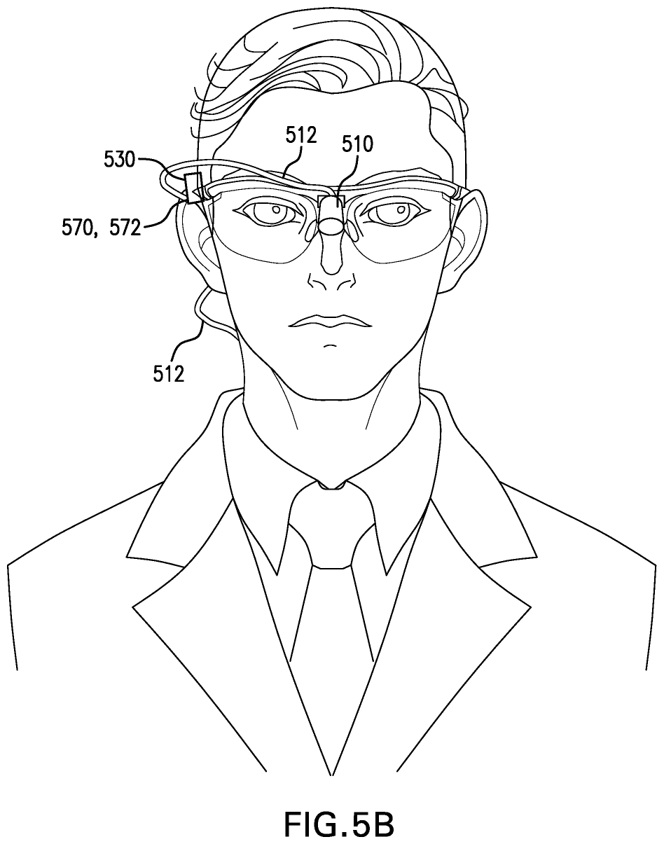

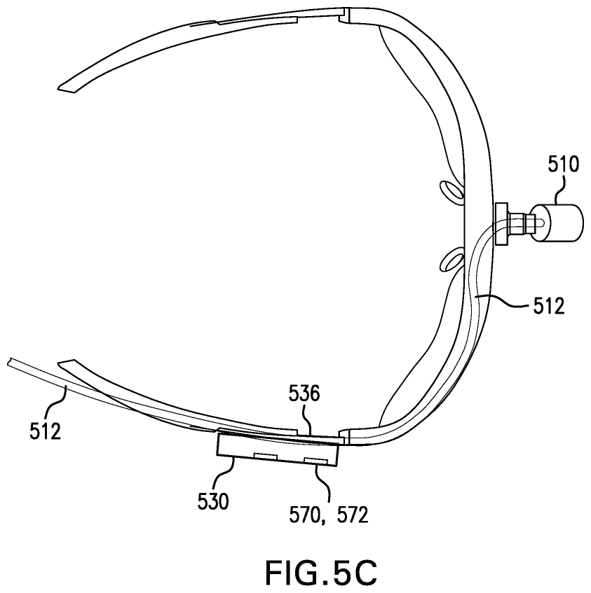

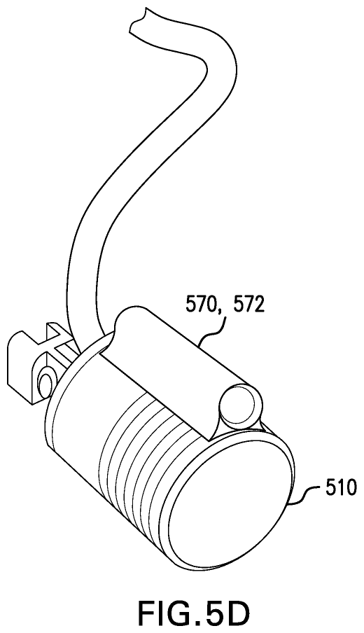

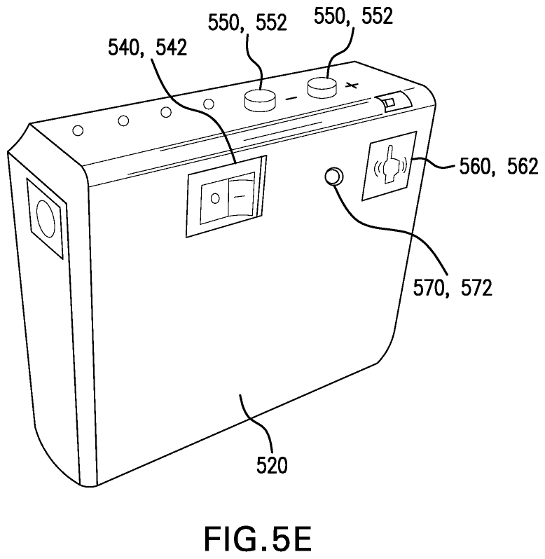

FIGS. 5A-5C show one embodiment of a touch-free lighting system 500. FIG. 5A shows a side view of touch-free lighting system 500. FIG. 5B shows a front view of touch-free lighting system 500. FIG. 5C shows a top view of touch-free lighting system 500.

Touch-free lighting system 500 may include a light 510. Light 510 is shown as a loupe light, but may be any light for which hands-free and/or touch-free operation is desired.

Touch-free lighting system 500 may include a battery housing 520. Battery housing 520 may be configured to contain a battery. Battery housing 520 may include an attachment 526 so that battery housing 520 may be coupled to a user. Attachment 526 may include a clip, a loop, a hook-and-loop fastener, a strap, or any other suitable device which allows battery housing 520 to be coupled to a user.

Battery housing 520 may be configured to be coupled to piece of clothing or accessory worn by a user. For example, battery housing 520 may be configured to be clipped to a back of a collar worn by a user. As another example, battery housing 520 may be configured to be attached to an eyewear retainer or necklace worn by a user.

Touch-free lighting system 500 may include a pod 530. Pod 530 may include an attachment 536. Attachment 536 may include a clip, a loop, a hook-and-loop fastener, a strap, or any other suitable device which allows pod 530 to be coupled to a user.

Pod 530 may be configured to be coupled to eyewear and/or clothing worn by a user. For example, pod 530 may be configured to be clipped to a temple of eyewear worn by a user. As another example, pod 530 may be attached to a collar of a piece of clothing worn by a user.

Light 510, battery housing 520, and pod 530 may be connected by one or more wires 512 in any suitable arrangement. For example, a wire 512 may connect light 510 to battery housing 520. As another example, a wire 512 may connect light 510 to pod 530, and another wire 512 may connect pod 530 to battery housing 520. As yet another example, a wire 512 may connect light 510 to battery housing 520, and another wire 512 may connect pod 530 to battery housing 520.

Light 510, battery housing 520, and pod 530 may be discrete or combined into one or more devices. For example, light 510 and pod 530 may be combined into a single device.

Touch-free lighting system 500 may include a power switch 540. Power switch 540 may be coupled to one or more of light 510, battery housing 520, pod 530, or any other part of touch-free lighting system 500. Power switch 540 may be configured to to turn light 510 on and off. Power switch 540 may include a rocker switch 542. Power switch 540 may include one or more buttons, switches, or any other suitable device.

Touch-free lighting system 500 may include a brightness control 550. Brightness control 550 may be coupled to one or more of light 510, battery housing 520, pod 530, or any other part of touch-free lighting system 500. Brightness control 550 may be configured to adjust a brightness of light 510. Brightness control 550 may include one or more buttons 552.

Touch-free lighting system 500 may include at least one touch-sensitive sensor 560. Touch-sensitive sensor 560 may be coupled to one or more of light 510, battery housing 520, pod 530, or any other part of touch-free lighting system 500. Touch-sensitive sensor 560 may be configured to turn light 510 on and off when touched. Touch-sensitive sensor 560 may be configured to adjust a brightness of light 510 when touched. Touch-sensitive sensor 560 may be configured to change a brightness of light 510 with each touch. Touch-sensitive sensor 560 may be configured to turn light 510 on and off, as well as adjust a brightness of light 510. For example, when light 510 is off, a first touch of touch-sensitive sensor 560 may turn on light 510 to a low brightness, and each successive touch may increase a brightness of light 510. When light 510 reaches a high or maximum brightness, a touch of touch-sensitive sensor 560 may turn off light 510. As another example, when light 510 is off, a first touch of touch-sensitive sensor 560 may turn on light 510 to a high or maximum brightness, and each successive touch may decrease a brightness of light 510. When light 510 reaches a low or minimum brightness, a touch of touch-sensitive sensor 560 may turn off light 510.

Touch-sensitive sensor 560 may be configured to be responsive to touch and/or near-touch. Touch-sensitive sensor 560 may be responsive to bare and/or clothed skin. Touch-sensitive sensor 560 may be configured to be touched or near-touched for a period of time before turning on or off light 510 to prevent inadvertent operation. For example, touch-sensitive sensor 560 may need to be touched or near-touched for 0.5 sec to 1 sec before turning on or off light 510. Touch-sensitive sensor 560 may be made any suitable size or shape. Touch-sensitive sensor 560 may be used alone or in conjunction with power switch 540 and/or brightness control 550. Touch-sensitive sensor 560 may include a capacitive touch sensor 562 or any other suitable touch-sensitive sensor.

Touch-free lighting system 500 may include at least one touch-free sensor 570. Touch-free sensor 570 may be activated without being touched. Touch-free sensor 570 may be coupled to one or more of light 510 (as shown in FIG. 5D), battery housing 520 (as shown in FIG. 5E), pod 530 (as shown in FIGS. 5A-5C), or any other part of touch-free lighting system 500. Touch-free sensor 570 may be configured to turn light 510 on and off when activated. Touch-free sensor 570 may be configured to adjust a brightness of light 510 when activated. Touch-free sensor 570 may be configured to change a brightness of light 510 with each activation. Touch-free sensor 570 may be configured to turn light 510 on and off, as well as adjust a brightness of light 510. For example, when light 510 is off, a first activation of touch-free sensor 570 may turn on light 510 to a low brightness, and each successive activation may increase a brightness of light 510. When light 510 reaches a high or maximum brightness, an activation of touch-free sensor 570 may turn off light 510. As another example, when light 510 is off, a first activation of touch-free sensor 570 may turn on light 510 to a high or maximum brightness, and each successive activation may decrease a brightness of light 510. When light 510 reaches a low or minimum brightness, an activation of touch-free sensor 570 may turn off light 510.

Touch-free sensor 570 may include an infrared (IR) sensor 572. IR sensor 572 may have a field of view that is fixed or adjustable. IR sensor 572 may be configured to activate when it detects an appropriate gesture by a part of the body, such as a hand gesture, in its field of view.

IR sensor 572 may be configured to activate when a part of the body such as a hand is waved through its field of view. IR sensor 572 may be configured to distinguish between a part of the body waved quickly and waved slowly through its field of view. IR sensor 572 may be configured to activate only when a part of the body is waved quickly through its field of view, and to have no response when a part of the body is waved slowly through its field of view. For example, a quick wave may take approximately 1 second or less to pass through a field of view of IR sensor 572. IR sensor 572 may be configured to activate only when a part of the body is waved slowly through its field of view, and to have no response when a part of the body is waved quickly through its field of view. For example, a slow wave may take approximately 2 to 5 seconds to pass through a field of view of IR sensor 572. IR sensor 572 may be configured to activate only when a part of the body is waved from left to right, right to left, up to down, down to up, nearer to farther, farther to nearer, or any other direction, or any sequence or combination of directions.

IR sensor 572 may be configured to activate when the fingers of a hand are waved through its field of view. IR sensor 572 may be configured to recognize the pattern of the individual fingers of a hand being waved through its field of view. For example, IR sensor 572 may be configured to recognize or count one, two, three, four, or five fingers being waved through its field of view, and to have no response when not enough fingers are waved through its field of view. IR sensor 572 may be configured with a suitable field of view, such as on the order of a width of a finger and/or a distance between adjacent fingers when spread out.

IR sensor 572 may be configured to activate when a part of the body such as a hand is held at a predetermined distance away from IR sensor 572 in its field of view. IR sensor 572 may be configured to activate when a part of the body such as a hand is held for a predetermined period of time in its field of view. For example, IR sensor 572 may be configured to activate when a part of the body such as a hand is held for approximately 1 second or more in its field of view. IR sensor 572 may be configured to activate when a part of the body such as a hand is held at a predetermined distance away from IR sensor 572, and for a predetermined period of time in its field of view.

IR sensor 572 may include a passive and/or an active IR sensor. Touch-free sensor 570 may include an ultrasonic sensor, microwave sensor, optical sensor, or any other suitable sensor which does not require touch or contact to activate.

While the foregoing has been with reference to particular embodiments of the invention, it will be appreciated by those skilled in the art that changes in these embodiments may be made without departing from the principles and spirit of the invention.

What is claimed is:

1. A hands-free lighting system comprising:
a light;
a battery housing coupled to the light, the battery housing configured to be worn by a user; and
a power switch coupled to the battery housing, the power switch configured to be operated by a part of the arm of the user other than the hands, wherein the power switch includes a touch-sensitive device having a capacitive surface.

2. The lighting system of claim 1, wherein the power switch is located on the battery housing.

3. The lighting system of claim 1, wherein the power switch includes a rocker switch.

4. The lighting system of claim 1, wherein the power switch includes a power button.

5. The lighting system of claim 1, wherein the power switch includes an on button and an off button.

6. The lighting system of claim 5, wherein the on button and the off button are configured to be worn on a first side and a second side, respectively, of the user.

7. The lighting system of claim 5, wherein the on button and the off button are configured to be operated by a first arm and a second arm, respectively, of the user.

8. The lighting system of claim 5, wherein the on button and the off button are located on one or more pods coupled to the battery housing.

9. The lighting system of claim 1, wherein the light is coupled to the battery housing by a wire, and wherein the power switch is located on the wire.

10. The lighting system of claim 1, wherein the part of the arm is an inside of an elbow.

11. The lighting system of claim 1, wherein the touch-sensitive device is configured to be touched for a period of time before turning the light on or off.

12. The lighting system of claim 11, wherein the period of time is 0.5 seconds to 1 second.

13. The lighting system of claim 1, further comprising:
a brightness control coupled to the battery housing, the brightness control configured to be operated by a part of the arm other than the hands.

14. The lighting system of claim 13, wherein the brightness control includes a brightness control button.

15. The lighting system of claim 13, wherein the power switch and the brightness control are configured to be worn on a first side and a second side, respectively, of the user.

16. The lighting system of claim 13, wherein the power switch and the brightness control are configured to be operated by a first arm and a second arm, respectively, of the user.

17. The lighting system of claim 13, wherein the power switch and the brightness control are located on one or more pods coupled to the battery housing.

18. The lighting system of claim 13, wherein the light is coupled to the battery housing by a wire, and wherein the brightness control is located on the wire.

19. A hands-free lighting system comprising:
a light;
a battery housing coupled to the light, the battery housing configured to be worn by a user, and
a power switch means coupled to the battery housing, the power switch means configured to be operated by a part of the arm of the user other than the hands, wherein the power switch means includes a touch-sensitive device having a capacitive surface.

20. A method of operating a hands-free lighting system, the method comprising:
turning a light on and off by using a part of the arm other than the hands to touch a touch-sensitive device having a capacitive surface, the touch-sensitive device coupled to a battery housing, the battery housing coupled to the light.
